(19) United States
(12) Patent Application Publication
(10) Pub. No.: US 2005/0225083 A1
(43) Pub. Date: Oct. 13, 2005

(54) Pipe system and method for its manufacture

(76) Inventor: Anthony Thomas Cole, GD Rijswijk (NL)

Correspondence Address: Eugene R Montalvo;Shell Oil Company, Intellectual Property, P O Box 2463, Houston, TX, 77252-2463, US

(21) Appl. No.: 10/506,199

(22) PCT Filed: Feb. 28, 2003
(86) PCT No.: PCT/EP03/00291

§ 371 Date: Sep. 20, 2004

(30) Foreign Application Priority Data
Mar. 1, 2002 (EP) 02075824.9

(51) Int. Cl. F16L 25/00

(52) U.S. Cl. 285/333

(57) ABSTRACT

A pipe system for transport of corrosive fluids, such as crude oil or natural gas, having a corrosion-prone tubular member, which is coated with an inner corrosion-resistant lining. The tubular member and inner lining provide a flat end in a plane orthogonal to a longitudinal axis of the tubular member, which flat end is connected to a flat end of a threaded tubular coupling member having a corrosion-resistant inner surface and screw thread. The corrosion-prone tubular member coated with the corrosion-resistant lining may be manufactured in long lengths and cut into a desired lengths whereupon each coupling member may be welded to the flat end of said tubular member and lining in a single butt welding operation.

The invention relates to a pipe system which is provided with a corrosion resistant lining for transport of corrosive fluids, such as crude oil and/or natural gas, and to a method for manufacturing such a pipe system.

U.S. Pat. No. 6,273,474 discloses a lined pipe system wherein the screw thread connectors for joining adjacent tubulars are partly made of corrosion resistant material and partly of a corrosion prone material, so that if corrosive fluids reach the corrosion prone part of the screw thread the pipe system may be damaged.

European patent application 0190092 discloses a pipe system wherein a corrosion resistant PTFE inner lining extends into the corrosion resistant threaded coupling members, so that the lining can only be inserted into the pipe after the coupling members have been joined to the pipes.

Another lined pipe system is disclosed in U.S. Pat. No. 6,042,153; it can be used not only in oil and/or gas wells, but also for gas drilling purposes and for transporting corrosive liquids. In said system, the pipes have an inner lining of a corrosion-resistant material and the coupling piece is mainly made of a more inexpensive, corrosion-prone metal. Since brine, H₂S and CO₂ can attack the outside of the pipe ends as well as the central inner part of coupling piece where the two pipe ends join each other, for example in the case of oil drilling, said parts are made of a corrosion-resistant material in the aforesaid system.

A drawback of said known system is the fact that it has appeared that corrosion nevertheless occurs on the tubular coupling members and the coupling piece, and that the connection can fail relatively quickly. Furthermore, the coupling piece is relatively complicated to manufacture.

An object of the invention is to provide an inexpensive lined pipe system which is easy to manufacture and which is adequately protected against corrosion and consequently has a long life.

The pipe system according to the invention comprises at least one tubular member of a substantially corrosion-prone metal with an inner lining of a corrosion-resistant material, which tubular member and inner lining are connected to a threaded tubular coupling member which has an inner surface and a screw thread consisting of a corrosion-resistant material, wherein the tubular member is connected to the threaded tubular coupling member in a plane which is substantially orthogonal to a longitudinal axis of the tubular member, and the inner lining is also cut in said plane and connected to the coupling member in said plane.

In the pipe system according to the invention the inner surface of the tubular coupling members and the surface of at least the screw thread of a coupling piece that may be screwed between the coupling members consists of a corrosion-resistant material. In practice it has become apparent that corrosive liquid penetrates beyond the corrosion-resistant metal in the systems known from U.S. Pat. No. 6,042,153 and U.S. Pat. No. 6,273,474, as a result of which harmful corrosion of the surfaces of the screw thread connectors may locally occur yet. The present invention prevents this phenomenon.

In a first embodiment of the pipe system according to the invention, the tubular coupling member mainly consists of a corrosion-prone metal, with the surface being lined with a corrosion-resistant material. The advantage of this is that the larger part of the tubular coupling members can be made of an inexpensive metal.

A second drawback of the system known from U.S. Pat. No. 6,042,153 is the relatively low tensile strength of the said connection. With the known system, which comprises conical screw thread, the thickness of the pipe wall gradually decreases towards the end, as a result of which the strength of the connection decreases. Furthermore, the presence of the screw thread has a negative effect on the strength of the material. Consequently, it is another object of the invention to provide a pipe system which exhibits a high tensile strength.

In a second embodiment of the pipe system according to the invention, the tubular coupling member is to that end made entirely of a corrosion-resistant metal, and the corrosion-resistant metal preferably has a tensile strength greater than that of the corrosion-prone metal. Another advantage of this embodiment is the fact that it is easy to manufacture.

Preferably, each tubular coupling member is connected in a substantially flat plane which is orthogonal to a longitudinal axis of the tubular member, to the common ends of the tubular member and the lining by means of butt welding, forge welding, brazing, amorphous bonding or diffusion joining, or similar methods. The tubular members and the inner lining thereof can be cut to the desired size in a simple manner, for example, after which the tubular coupling members are likewise welded to the flat end face of the tubular members in a simple manner.

In another embodiment, the screw thread of the coupling piece is lined with a corrosion-resistant material. In yet another embodiment, the coupling piece is made entirely of a corrosion-resistant metal.

Preferably, the screw thread of the coupling piece is internal screw thread, and the screw thread of the pipes is external screw thread. Also preferably, the screw thread is conical screw thread, or the diameter of the screw thread decreases in steps towards the end of the pipe.

Furthermore, the coupling piece preferably includes an annular stop at the centre, against which the pipe ends are screwed, as a result of which leakage is prevented and the depth to which the pipes are to be screwed into the coupling piece is clearly defined.

The invention furthermore relates to a method for manufacturing a pipe system, wherein a tubular member of a desired length is made of a substantially corrosion-prone metal with an inner lining of a corrosion-resistant material, after which tubular coupling members, which are provided with screw thread and whose inner surface and the surface of the screw thread consists of a corrosion-resistant material, are connected to the ends of said tubular member and said lining, wherein the tubular member is connected to the threaded tubular coupling member in a plane which is substantially orthogonal to a longitudinal axis of the tubular member, and the inner lining is also cut in said plane and is connected to the coupling member in said plane.

The invention will now be explained in more detail by means of exemplary embodiments as shown in the figures, wherein the same reference numerals are used for the same parts, and wherein:

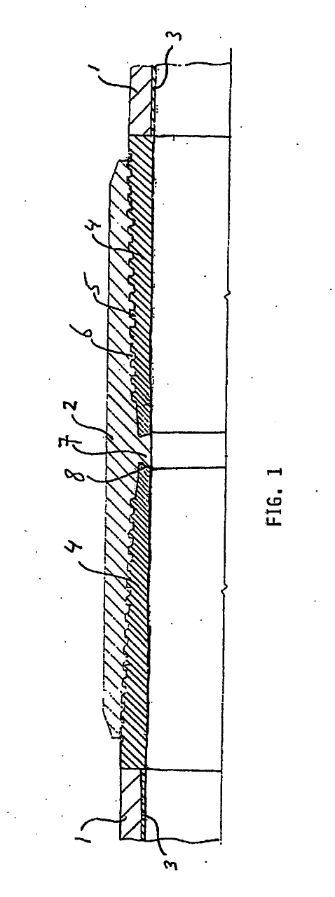

FIG. 1 is a longitudinal sectional view of first embodiment of a pipe system according to the invention.

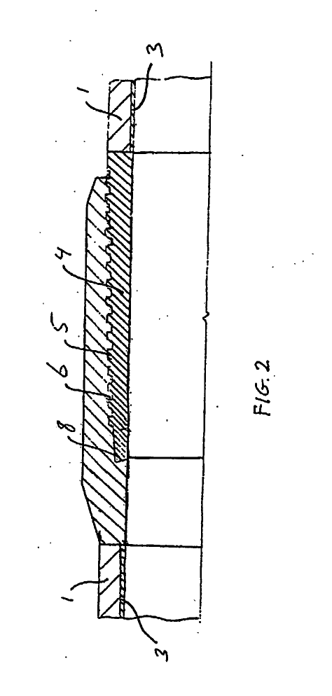

FIG. 2 is a longitudinal sectional view of second embodiment of a pipe system according to the invention.

According to FIG. 1, a pipe system comprises two identical pipes, which consist of a tubular member 1, a lining 3 and a tubular coupling member 4 at both ends, which pipes are coupled together by means of a coupling piece 2.

The tubular members 1 are made of an inexpensive corrosion-prone material, such as carbon steel, and they have an inner lining 3 of a corrosion-resistant material, such as a 22 Cr alloy. Lining 3 may also be made of a plastic material, however.

The tubular members 1 can be made to size in a simple manner, for example by cutting at planes 10 and 11 that are substantially orthogonal to a longitudinal axis 12 of the tubulars member 1. Subsequently, tubular coupling members 4 are joined, for instance by butt and/or forge welding, to the end of tubular members 1 and lining 3, which tubular coupling members 4 are made of a massive corrosion-resistant metal, such as the aforesaid 22 Cr alloy. The tubular coupling members 4 are externally provided with a male conical screw thread 5. Since the entire tubular coupling member 4 is made of a corrosion-resistant metal, also the entire surfaces of the screw threads 5 made of a corrosion-resistant material. Alternatively, however, only the entire surface of the screw threads 5 is coated with a corrosion-resistant lining, for example a Teflon (PTFE) lining, whilst the rest of the tubular coupling member 4 may be made of an inexpensive, corrosion-prone metal.

The coupling piece 2 consists of a substantially cylindrical sleeve of a massive corrosion-resistant metal, such as the aforesaid 22 Cr alloy. The coupling piece is provided with internal screw thread 6. Furthermore, the coupling piece is centrally provided with an annular stop 7, against which the joining ends 4 of the pipes 1 are screwed so as to prevent leakage of liquid from the pipe system as much as possible. The mating end faces 8 of the joining ends 4 and the stop 7 are bevelled so as to enhance their sealing action. Also in this case it obtains that the illustrated coupling piece 2 is made entirely of a corrosion-resistant metal, but that alternatively only the surface of the screw thread is provided with a corrosion-resistant lining, with the rest of coupling piece 2 being made of an inexpensive, corrosion-prone metal.

The internal screw threads 6 of the coupling piece 2 may be of identical sense (left-hand/left-hand or right-hand/right-hand) or of opposite sense (left-hand/right-hand). In the latter case, the two pipes 1 can be coupled together without rotation, but only through rotation of the coupling piece 2. In that case, also the screw threads on the two joining ends 4 of the coupling piece must be of opposite sense.

FIG. 2 shows a similar pipe system, wherein however the aforementioned coupling piece 2 is not used to accomplish a connection. This system comprises two tubular members 1 having a lining 3, connected in the aforementioned manner with two different corrosion resistant tubular coupling members (4, 4′), one being male, the other being female. Preferably one tubular member 1 is connected with two different coupling members (4, 4′) so that each pipe can be screwed into every other pipe. Alternatively one pipe can be provided with two male coupling members (4) and another pipe can be provided with two female coupling members (4′).

In the pipe system shown in FIG. 2 the tubular members 1 and linings 3 are cut in planes 10 and 11 that are substantially orthogonal to a longitudinal axis 12 of the tubular members and butt welded to the coupling members (4,4′) in a single forge welding operation, such that the lined tubular members 1 can be manufactured in long lengths and then cut to desired lengths, whereupon the coupling members (4,4′) can be easily welded to the ends of the tubulars 1 and linings 3 in a single trip butt operation.

1. A pipe system for transport of corrosive fluids, such as crude oil or natural gas, the pipe system comprising:
at least one tubular member of a substantially corrosion-prone metal;
an inner lining of a corrosion-resistant material; and
a threaded tubular coupling member, wherein the tubular member and inner lining are connected to the threaded tubular coupling member and the threaded tubular coupling member has an inner surface and a screw thread consisting of a corrosion-resistant material, wherein the tubular member is connected to the threaded tubular coupling member in a plane which is substantially orthogonal to a longitudinal axis of the tubular member, and the inner lining is also cut in said plane and is connected to the coupling member in said plane.

2. The pipe system of claim 1, the pipe system further comprising at least two cylindrical tubular members of a substantially corrosion-prone metal with an inner lining of a corrosion-resistant material, wherein the tubular members are connected to the threaded tubular coupling member near both their ends, and at least one coupling piece, which is provided with female screw thread on two sides thereof, wherein the female screw threads can mate with male screw threads of the tubular coupling members, and wherein the inner linings, the inner surfaces of the tubular coupling members and the surfaces of the screw threads of the coupling piece and of the threaded tubular coupling members consist of a corrosion-resistant metal.

3. The pipe system of claim 1, wherein each tubular coupling member mainly consists of a corrosion-prone metal, with the surface being lined with a corrosion-resistant material.

4. The pipe system of claim 1, wherein each tubular coupling member is made entirely of a corrosion-resistant metal.

5. The pipe system of claim 4, wherein the corrosion-resistant metal has a tensile strength greater than that of the corrosion-prone metal.

6. The pipe system of claim 4, wherein the tubular coupling members are connected to the common ends of the tubular members and the lining in planes that are substantially orthogonal to a longitudinal axis of the tubular members by means of butt welding, forge welding, brazing, amorphous bonding or diffusion joining.

7. The pipe system of claim 2, wherein the coupling piece is made entirely of a corrosion-resistant metal.

8. The pipe system of claim 2, wherein the coupling piece includes an annular stop at the center, against which the ends of the tubular coupling members are screwed.

9. A method for manufacturing a pipe system for transport of corrosive fluids, the method comprising the steps of:
providing a tubular member of a desired length made of a substantially corrosion-prone metal with an inner lining of a corrosion-resistant material;
providing tubular coupling members comprising screw threads wherein an inner surface of the tubular member and the surface of the screw threads consists of a corrosion-resistant material and are connected to an end of the tubular member and the lining, such that the tubular member is connected to the threaded tubular coupling member in a plane which is substantially orthogonal to a longitudinal axis of the tubular member, and the inner lining is also cut in said plane and is connected to the coupling member in the plane.

10. The method of claim 9, wherein the ends of the tubular member and inner lining are joined to each coupling member in the planes by butt welding.

11. The method of claim 9, wherein after the tubular member is provided with a corrosion-resistant lining the thus lined tubular member is cut to a desired length such that a flat end face is formed in said orthogonal plane, whereupon said flat end face of the lined tubular member is connected to a flat end face of a coupling member in a single trip butt welding operation.

12. The method of claim 9, wherein the ends of the tubular member and inner lining are joined to each coupling member in the planes by brazing.

13. The method of claim 9, wherein the ends of the tubular member and inner lining are joined to each coupling member in the planes by amorphous bonding.

14. The method of claim 9, wherein the ends of the tubular member and inner lining are joined to each coupling member in the planes by diffusion joining.

15. The method of claim 9, wherein the ends of the tubular member and inner lining are joined to each coupling member in the planes by forge welding.
